(19) United States
(12) Patent Application Publication
(10) Pub. No.: US 2025/0154922 A1
(43) Pub. Date: May 15, 2025

(54) GASEOUS INJECTOR PREPARATION METHOD FOR COLD ENGINE START

(71) Applicant: Cummins Inc., Columbus, IN (US)

(72) Inventors: Michael R. Tidwell, Bloomington, IN (US); Nahom Abebe Wondimu, Columbus, IN (US); Karthik Sethuraman, Columbus, IN (US); Joao Paulo da Silva, Columbus, IN (US); Aditya Vidyadhar Bhagwat, Columbus, IN (US); Timothy J. Viola, Columbus, IN (US)

(21) Appl. No.: 18/926,652

(22) Filed: Oct. 25, 2024

Related U.S. Application Data
(60) Provisional application No. 63/598,600, filed on Nov. 14, 2023.

(51) Int. Cl. F02M 21/02; F02M 43/04

(52) U.S. Cl. CPC F02M 21/0254; F02M 21/0275; F02M 43/04

(57) ABSTRACT

An engine system includes a gaseous fuel injection system including a plurality of gaseous fuel injectors configured to inject gaseous fuel for combustion in a plurality of cylinders and an electronic control system operatively coupled with the gaseous fuel injection system. The electronic control system is configured to determine whether to perform a break loose operation of the plurality of injectors, energize each of the plurality of gaseous fuel injectors with multiple voltage pulses in response to a determination to perform the break loose operation, and after the energization commence ignition to rotate the engine.

### BACKGROUND

The present application relates to gaseous fuel injector preparation for cold engine start and related apparatuses, processes, systems, and techniques. Gaseous fuel injectors may be provided in a number of configurations including, for example, spark ignition direct injection (SIDI) configurations, spark ignition port injection configurations, and a number of dual-fuel and multi-fuel configurations operable to combust a combination of gaseous fuel and one or more other fuels. While providing substantial utility, performance of gaseous fuel injectors may suffer in relation to cold engine start conditions. There remains a substantial need for the unique apparatuses, processes, systems, and techniques disclosed herein.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention as set forth in the claims following this disclosure includes and protects such alterations, modifications, and further applications of the example embodiments as would occur to one skilled in the art with the benefit of the present disclosure.

### SUMMARY OF THE DISCLOSURE

Some embodiments comprise unique gaseous fuel injector preparation methods. Some embodiments comprise unique gaseous fuel injector preparation systems. Some embodiments comprise unique gaseous fuel injector preparation apparatuses. Further embodiments, forms, objects, features, advantages, aspects, and benefits shall become apparent from the following description and drawings.

### BRIEF DESCRIPTION OF THE DRAWINGS

FIG. 1 is a schematic diagram illustrating certain aspects of an example engine system.

FIG. 2 is a schematic diagram illustrating certain aspects of the example engine system of FIG. 1.

FIG. 3 is a schematic diagram illustrating certain aspects of example controls.

FIG. 4 is a graph illustrating certain aspects of an example of interleaved sets of voltage pulses.

FIG. 5 is a graph illustrating certain aspects of an example engine cold start procedure.

FIG. 6 is a flow diagram depicting certain aspects of an example control process

FIG. 7 is a state flow diagram depicting certain aspects of example controls.

FIG. 8 is a flow diagram depicting certain aspects of an example control process.

### DETAILED DESCRIPTION OF EXAMPLE EMBODIMENTS

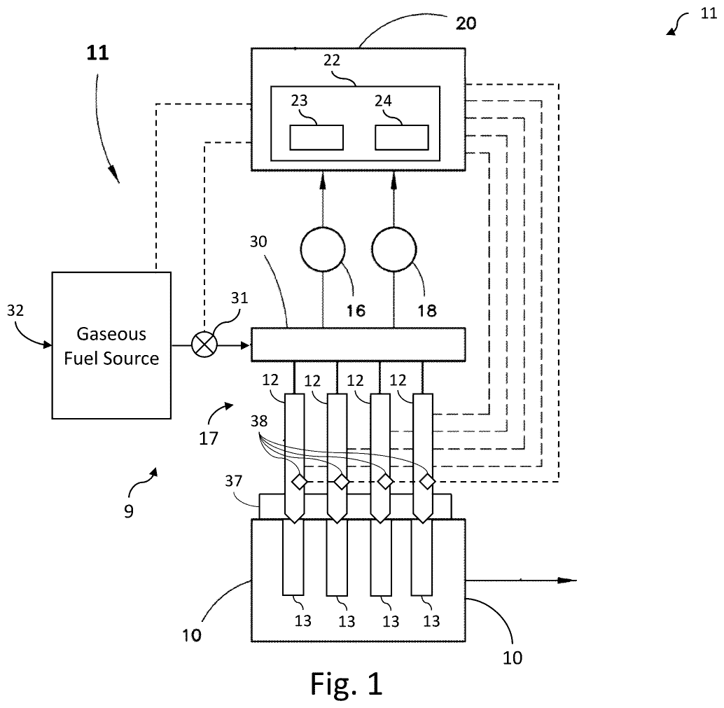

With reference to FIG. 1, there is illustrated a system 11 comprising an engine 10 and a gaseous fueling system 9. Gaseous fueling system 9 is configured to supply a gaseous fuel, such as such as natural gas, hydrogen, bio-derived gaseous fuels, hydrogen, mixed gases fuels or other gaseous fuels for combustion by engine 10. In the illustrated example, gaseous fueling system 9 is the sole fuel injection system of system 11. In other embodiments, gaseous fueling system 9 may be provided in combination with other gaseous or non-gaseous fueling systems, for example, in the form of dual-fuel or multi-fuel engines.

Engine 10 comprises combustion chambers 13 (also referred to as cylinders) of a reciprocating piston-in-cylinder-type engine which are configured to generate mechanical power from the combustion of gaseous fuel supplied by gaseous fuel injectors 12 (also referred to herein as injectors 12). Injectors 12 are in fluid communication with respective combustion chambers 13 of the engine 10 and are structured to inject gaseous fuel which is provided to their respective combustion chambers 13. In the illustrated embodiment, injectors 12 are configured and provided as direct fuel injectors configured to inject fuel directly into respective combustion chambers 13 of engine 10. Other embodiments may include other types and configurations of injectors such as port fuel injectors configured to inject fuel directly into respective ports of intake manifold 37 leading to respective combustion chambers 13 of engine 10 and embodiments including injectors located at an intake air throttle body wherein the injectors may not be closely coupled with specific cylinders.

In the illustrated embodiment, four injectors 12 and four combustion chambers 13 are depicted, it being appreciated that engine 10 may include fewer or greater numbers of injectors 12 and combustion chambers 13. System 11 may be provided in a number of forms including as a prime mover system (or component of a prime mover system) of vehicle, a genset, other power-load system.

In the illustrated embodiment, the gaseous fueling system 9 includes a gaseous fuel supply and injection system 17 and a gaseous fuel source 32. Gaseous fuel supply and injection system 17 includes rail 30 and one or more sets of injectors 12 operatively coupled with and supplied with gaseous fuel from a respective one of the rail 30. The rail 30 is, in turn, configured to receive pressurized fuel from gaseous fuel source 32.

The gaseous fuel source 32 may include a high pressure tank configured to store a supply of gaseous fuel at high pressure. In some embodiments, gaseous fuel source 32 may include additional elements such as a compressor configured to compress gaseous fuel received from the fuel tank supply compressed gaseous fuel to the rail 30, and/or and accumulator as well as electronically controllable valves configured to control supply of gaseous fuel to and from the accumulator and/or the rail 30.

It shall be appreciated that the illustrated form of gaseous fueling system 9 is but one example of a fueling system according to the present disclosure. In other embodiments, the gaseous fueling system 9 may be configured and provided as another type of gaseous fueling system, for example, as a gaseous hydrogen fueling system. In other embodiments, gaseous fueling system 9 may be configured and provided in other forms, for example, as a high-pressure common-rail diesel fuel injection system or other types of fueling systems.

System 11 further includes electronic control system (ECS) 20 in operative communication with engine 10 and systems and components thereof including, for example, gaseous fuel source 32, fuel shut-off valve (FSOV) 31, injectors 12, or more pressure sensors 16, one or more temperature sensors 18, injector pressure sensors 38, among other components and systems.

ECS 20 is configured to control one or more aspects of engine 10, including controlling the injectors 12. Accordingly, ECS 20 may be in communication with the injectors 12 and configured to command each fuel injector 12 on and off at prescribed times to inject fuel into the engine 10 as desired. ECS 20 typically include at least one electronic control unit (ECU) 22 also sometimes referred to as an engine control module (ECM). ECU 22 is configured to execute operations of ECS 20 as described further herein and, in some embodiment, may include additional ECUs configured to execute operations of ECS 20 as described further herein.

ECS 20 may be further structured to control other parameters of engine 10, which may include aspects of engine 10 that may be controlled with an actuator activated by ECS 20. For example, ECS 20 may be in communication with actuators and sensors for receiving and processing sensor input and transmitting actuator output signals. Actuators may include, but not be limited to, injectors 12. The sensors may include any suitable devices to monitor operating parameters and functions of the system 11. For example, the sensors may include one or more pressure sensors 16, one or more temperature sensors 18, and injector pressure sensors 38. The one or more pressure sensors 16 are in communication with the rail 30 and structured to communicate a measurement of the pressure of gaseous fuel in the rail 30 (also referred to as fuel rail pressure or rail pressure) to the ECS 20. The one or more temperature sensors 18 are in communication with the rail 30 and structured to communicate a measurement of the temperature of gaseous fuel in the rail 30 (also referred to as fuel rail temperature or rail temperature) to the ECS 20. Injector pressure sensors 38 in communication with and configured to sense a pressure of respective ones of the injectors 12. Some embodiments may not include injector pressure sensors 38 and may instead utilize other sensors configured to sense fuel pressure, for example, pressure sensor 16.

As will be appreciated by the description that follows, the techniques described herein relating to fuel injector or fuel injection parameters can be implemented in ECS 20, which may include one or more controllers for controlling different aspects of the system 11. In certain embodiments, the ECS 20 comprises one or more electronic control units (ECU) such as an engine control unit or engine control module. The ECS 20 may be comprised of digital circuitry, analog circuitry, or a hybrid combination of both of these types. Also, the ECS 20 may be programmable, an integrated state machine, or a hybrid combination thereof. The ECS 20 may include one or more microcontrollers, microprocessors, application specific integrated circuits (ASIC), arithmetic logic units (ALUs), processors, memories, limiters, conditioners, filters, format converters, or the like. In one form, the ECS 20 is of a programmable variety that executes algorithms and processes data in accordance with operating logic that is defined by programming instructions (such as software or firmware). Alternatively or additionally, operating logic for the ECS 20 may be at least partially defined by hardwired logic or other hardware.

In the illustrated example, ECU 22 of ECS 20 comprises one or more microcontrollers 23 and one or more ASICs 24 which are configured to participate in controlling operations of injectors 12. Injector control logic and injector driver circuitry and functionality may be provided in or distributed among the one or more microcontrollers 23 and one or more ASICs 24. It shall be appreciated that the illustrated configuration is but one example of the ECU and ECS configurations contemplated by the present disclosure.

In addition to the types of sensors described herein, any other suitable sensors and their associated parameters may be encompassed by the system and methods. Accordingly, the sensors may include any suitable device used to sense any relevant physical parameters including electrical, mechanical, and chemical parameters of the engine system 11. As used herein, the term sensors may include any suitable hardware and/or software used to sense or estimate any engine system parameter and/or various combinations of such parameters either directly or indirectly.

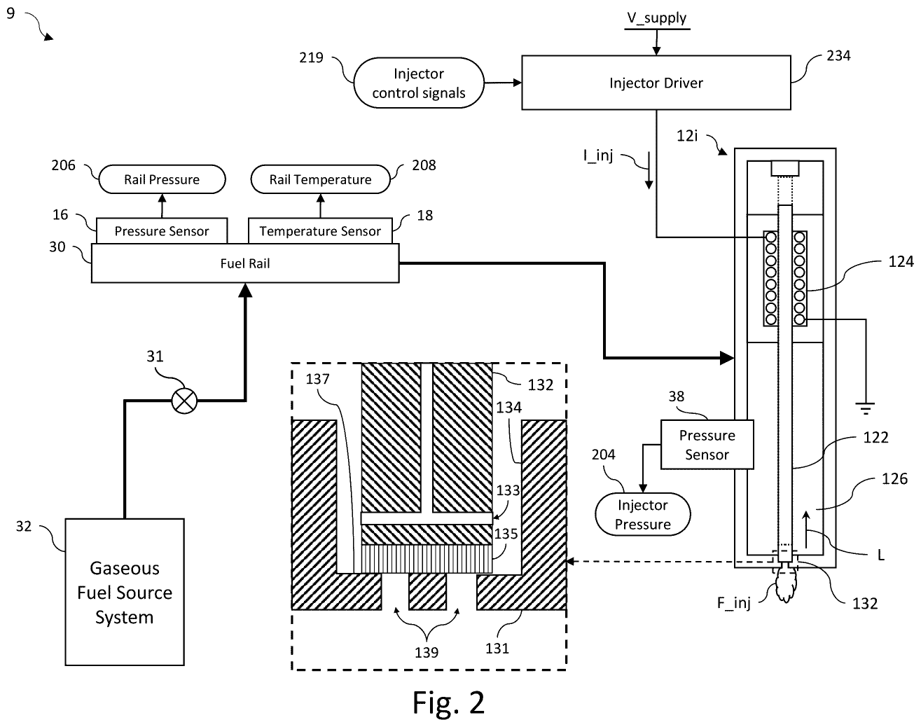

With reference to FIG. 2, there are illustrated further details of an example embodiment of gaseous fueling system 9. An example gaseous fuel injector 12i (also referred to as injector 12i) corresponding to any of the injectors 12 is depicted and is operatively coupled with an injector driver 234 which is configured to receive one or more injector control signals 219.

In some embodiments, the one or more microcontrollers 23 may provide programming or settings to the one or more ASICs 24 which are configured as injector drivers. Such programming and settings are utilized in controlling operation of the injectors 12. Such programming or settings may selectably allow and suppress normal injector control and selectably allow and suppress break loose injector control. The one or more microcontrollers 23 may communicate with the one or more ASICs 24 via one or more logic channels which communicate a voltage that can be selectably switched between a low or off voltage (e.g., 0V) and an on or high voltage (e.g., 5V or 3.3 V) which may be utilized to time the injector turning on and turning off. The one or more microcontrollers 23 may communicate the one or more ASICs 24 via a serial peripheral interface (SPI) which can be used to send values for programmable settings utilized by the one or more ASICs 24, for example, current levels and diagnostic settings.

Normal injector control according to the present disclosure refers to injector control adapted, configured, or utilized to control injector operation to provide a desired engine output torque, power, and/or speed as a primary or exclusive control basis or objective. Break loose injector control according to the present disclosure refers to injector control adapted, configured, or utilized to mitigate or eliminate stuck injector conditions or to break a stuck injector loose to restore desired function of one or more injectors as a primary or exclusive control basis or objective. Such programming or settings may provide information for controlling timing, duration, order, frequency, phase, magnitude and other attributes of voltage pulses and sets of voltage pulses utilized in controlling injectors 12. Such information may be provided for normal injector control and for break loose injector control.

A number of sensor signals and associated control system parameters are illustrated in FIG. 2. Injector pressure 204 is provided by an illustrated one of pressure sensors 38 and is indicative of a pressure of gaseous fuel of injector 12i. Rail pressure 206 is provided by the one or more pressure sensors 16 and is indicative of a pressure of gaseous fuel of fuel rail 30. Rail temperature 208 is provided by the one or more temperature sensors 16 and is indicative of a temperature of gaseous fuel of fuel rail 30.

An injector-on state of the one or more injector control signals 219 may be effective to actuate one or more switches of injector driver 234 which are operatively coupled with a system voltage source (V_supply) and configured to selectably supply an injector current (I_inj) to solenoid 124 of injector 12i. The injector current (I_inj) is effective to energize solenoid 124 to induce lifting motion of injector armature 122 in the direction generally indicated by arrow L. In the lifted position (illustrated in phantom as denoted by dashed lines), injector armature 122 allows fuel supplied to injector gallery 126 to exit one or more apertures 139 of a tip 131 of injector 12 as an fuel injection (F_inj) directly into an associated combustion chamber of engine 10 or, alternatively, indirectly into the combustion chamber via injection into a port leading to the combustion chamber.

Injector armature 122 is operatively mechanically coupled with an injector needle 132 which is configured to move with injector armature 122 in response to injector current (I_inj). Injector needle 132 comprises or is mechanically coupled with elastomeric seal 135 which is oriented to face and abut a seating surface 137 of the tip 131 of injector 12i. In some embodiments, the elastomeric seal 135 may be fixed to the seating surface 137 rather than the injector needle 132.

Injector needle 132 and elastomeric seal 135 are moveable between a closed position, wherein elastomeric seal 135 contacts seating surface 137 (for example, as illustrated in FIG. 2) and an open position, wherein elastomeric seal 135 is spaced apart from seating surface 137. The movement of injector needle 132 and elastomeric seal 135 selectably opens and closes the one or more apertures 139 and thereby selectably permits or blocks the fuel injection (F_inj). The interface between elastomeric seal 135 and seating surface 137 presents a potential for injector sticking, for example, under cold temperature conditions. Injector sticking may elastomeric seal 135 being partially or completely stuck to seating surface 137 such that movement of injector needle 132 is partially or entirely inhibited or stopped notwithstanding the energization of solenoid 124 and resulting injector current (I_inj).

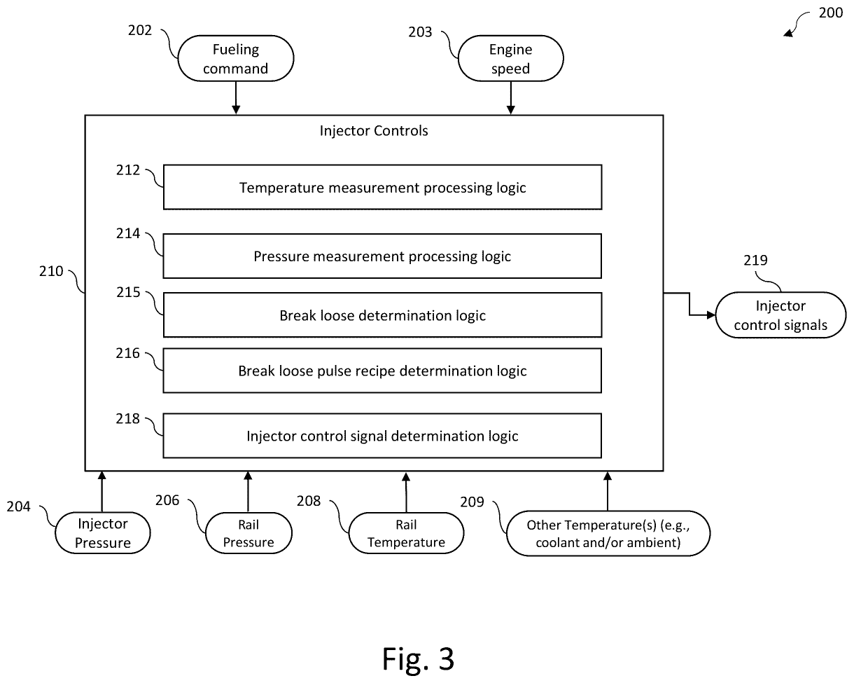

With reference to FIG. 3, there are illustrated example controls 200 which may be implemented in and operated by one or more components of an electronic control system such as ECS 20 or another electronic control system configured for operative communication with a fueling system. In some forms, at least a portion of controls 200 may be implemented in one or more electronic control units of an electronic control system such as ECU 22 or additional or alternative electronic control units.

Controls 200 include injector controls 210 which are configured to determine and output the one or more injector control signals 219 to control operation of an injector 12i in response to one or more inputs. In the illustrated example, injector controls 210 are configured to determine and output injector commands for a particular individual injector 12i. Controls 200 may include additional instances of injector controls the same as or similar to injector controls 210 which are configured to determine and output injector commands for other particular individual injectors.

In the illustrated example, injector controls 210 are configured to receive a plurality of inputs including fueling command 202, engine speed 203, injector pressure 204, rail pressure 206, and rail temperature 208. In other embodiments, injector controls 210 may be configured to receive additional or alternative inputs.

Fueling command 202 may include a fueling quantity (Q) and a fueling pressure (P). Fueling command 202 may be determined and provided to injector controls 210 in response to an operator input such as an accelerator pedal position or in response to automated operation of an electronic control system such as an engine cranking startup routine or an adaptive cruise control system. Engine speed 203 may be provided by an engine speed sensor. Engine speed 203 may be provided to injector controls 210 via a dedicated connection or via one or more communication networks.

Injector pressure 204 may be provided by the illustrated one of pressure sensors 38 which is in operative communication with and configured to sense a pressure of injector 12i. Injector pressure 204 may be provided to injector controls 210 via a dedicated connection or via one or more communication networks.

Rail pressure 206 may be provided by pressure sensor 16 which is in operative communication with and configured to sense a pressure of fuel rail 30 which is configured to supply fuel to injector 12i and may also be configured to supply fuel to other injectors. Rail pressure 206 may be provided to injector controls 210 via a dedicated connection or via one or more communication networks. Rail pressure 206 may be utilized as a rail pressure measurement according to the processes and controls disclosed herein and may be sampled repeatedly to determine multiple points or values of a rail pressure measurement.

Rail temperature 208 may be provided by temperature sensor 18 which is in operative communication with and configured to sense a temperature of fuel rail 30. Rail temperature 208 may be provided to injector controls 210 via a dedicated connection or via one or more communication networks. Rail temperature 208 may be utilized as a rail temperature according to the processes and controls disclosed herein and may be sampled repeatedly to determine multiple points or values of a rail temperature measurement.

Injector controls 210 comprise control circuitry configured to implement and execute control logic for processing the inputs received by injector controls 210 and to determine and output the one or more injector control signals 219. In the illustrated example the circuitry of injector controls 210 is configured to provide and execute temperature measurement processing logic 212, pressure measurement processing logic 214, break loose determination logic 215, break loose pulse recipe determination logic 216, and injector control signal determination logic 218. In other embodiments, the control logic provided by injector controls 210 may be differently organized with the aspects of one or more of the illustrated logic blocks being combined in a single block or units, divided into multiple blocks or units, and/or provided with additional or alternative blocks or units.

In the illustrated example, temperature measurement processing logic 212 and pressure measurement logic 214 are configured to make one or more determinations of gaseous fuel system temperature and gaseous fuel pressure, respectively. Temperature measurement processing logic 212 may utilize rail temperature 208 and/or one or more other temperatures 209, such as engine system coolant temperature, engine system oil temperature, and/or an ambient temperature of the engine system in making a temperature determination. In some embodiments, the temperature determination may comprise any one of the aforementioned examples. In some embodiments the temperature determination may comprise determining an average of two or more of the aforementioned examples. In some embodiments the temperature determination may utilize two or more of the aforementioned examples to perform a rationality check or sensor error condition check.

Pressure measurement processing logic 214 may utilize rail pressure 206 and/or injector pressure 204 in making a gaseous fuel pressure determination. In some embodiments, the gaseous fuel pressure determination may comprise either of the aforementioned examples. In some embodiments the gaseous fuel pressure determination may comprise an average of the aforementioned examples. In some embodiments the gaseous fuel pressure determination may utilize the aforementioned examples to perform a rationality check or sensor error condition check. In some embodiments the gaseous fuel pressure determination may comprise a pressure determination at or associated with a most recent engine stop or shut-down, a most recent key-off, or other most recent event indication a potentiality of a future cold engine start condition. In some embodiments the gaseous fuel pressure determination may comprise a pressure determination at or associated with a most recent engine start request, a most recent key-on, or other most recent event indication initiation of or prerequisite acts for a future cold engine start condition. In some embodiments pressure measurement processing logic 214 may be integrated or combined with one or more of temperature measurement processing logic 212 and/or other logic or controls.

Break loose determination logic 215 is configured to determine whether to perform a break loose operation of one or more gaseous fuel injectors. Such break loose determination may be based upon a temperature determination of temperature measurement processing logic 212 and/or a pressure determination of pressure measurement processing logic 214. Break loose determination logic 215 may evaluate a temperature determination of temperature measurement processing logic 212 with respect to one or more temperature thresholds to determine whether an engine cold start condition is present and, in some embodiments, may further determine a grade or severity of an engine cold start condition. Break loose determination logic 215 may additionally or alternatively evaluate a pressure determination of pressure measurement processing logic 214 with respect to one or more pressure thresholds to determine whether an elevated pressure shut down condition is present and, in some embodiments, may further determine a grade or severity of an elevated pressure shut down condition and/or its contribution or effect on an engine cold start condition and ultimately whether to perform a break loose operation of one or more gaseous fuel injectors. In some embodiments and break loose determination logic 215 may be integrated or combined with one or more of temperature measurement processing logic 212, pressure measurement processing logic 214, and/or other logic or controls.

Break loose pulse recipe determination logic 216 is configured to determine a recipe for energizing one or more gaseous fuel injectors with multiple voltage pulses. Such a recipe may comprise example magnitudes of multiple voltage pulses, an order, spacing, or separation of multiple voltage pulses or sets thereof, a timing or duration of multiple voltage pulses or a set thereof, a number of repetitions of multiple voltage pulses, and other characteristics of multiple voltage pulses. A plurality of such recipes may be determined and may vary in intensity, frequency, and/or repetition in response to a grade or severity of an engine cold start condition and/or a grade or severity of an elevated pressure shut down condition, for example, with greater intensity provided in response to an indication of greater grade or severity. In some embodiments break loose pulse recipe determination logic 216 may be integrated or combined with one or more of temperature measurement processing logic 212, pressure measurement processing logic 214, break loose determination logic 215, and/or other logic or controls.

Break loose determination logic 215 and break loose pulse recipe determination logic 216 are examples of controls to make determinations whether to perform break loose injector operation and what recipe of break loose injector operation to perform. Such determinations may comprises at least one of evaluating a temperature of the engine system and a pressure of the gaseous fuel system. Such determinations may also comprises evaluating at least one of a temperature of the engine system and a pressure of the gaseous fuel system, and determining a multiple voltage pulse recipe in response to the evaluating.

Injection control signal determination logic 218, is configured to determine and output the one or more injector control signals 219. Injector control signal determination logic 216 may operate in a normal injector control mode wherein the one or more injector control signals 219 may be determined in response to fueling command 202, engine speed 203, injector pressure 204, rail pressure 206, rail temperature 208, and other parameters such as intake manifold pressure, intake manifold temperature, mass air flow or other parameters. In the normal injector control mode break loose operation is suppressed and normal injector operation is allowed.

Injector control signal determination logic 218 may also operate in a break loose injector control mode wherein the one or more injector control signals 219 may be determined in response to a break loose recipe determined by break loose pulse recipe determination logic 216. In the break loose injector control mode normal injector operation is suppressed and break loose operation is allowed.

It shall be appreciated that suppression of break loose injector operation, normal injector operation, and, more generally, suppression of other controls, commands, acts or operations of the controls and control processes of the present disclosure may be effectuated in a number of manners. Such suppression may, for example, include one or more of disabling, suspending, non-execution, non-performance, overriding, turning-off, or otherwise preventing occurrence or resulting in the absence of occurrence of a control event, commands, act, or operation.

In some embodiments injector control signal determination logic 218 may be integrated or combined with one or more of temperature measurement processing logic 212, and pressure measurement processing logic 214, break loose determination logic, break loose pulse recipe determination logic 216, and/or other logic or controls.

It shall be further appreciated that injector control signal determination logic 218, break loose pulse recipe determination logic 216, break loose determination logic 215, pressure measurement processing logic 214, and/or temperature measurement processing logic 212 may be configured and provided as one or more lookup tables, maps or response surfaces which are configured and operable to provide an injector on-time command in response to the aforementioned inputs. In some embodiments, injector control signal determination logic 218, break loose pulse recipe determination logic 216, break loose determination logic 215, pressure measurement processing logic 214, and/or temperature measurement processing logic 212 may be configured and operable to solve one or more equations to determine an injector on-time command in response to various inputs. Some embodiments, may specify an injection event or injector actuation or operation in terms of a start angle and a stop angle of an engine crank angle.

It shall be appreciated that controls 200 are an example of controls that may be implemented in and executed by one or more components of an electronic control system to perform the acts of determining whether to perform a break loose operation of the plurality of injectors, in response to a determination to perform the break loose operation including energizing each of the plurality of gaseous fuel injectors with multiple voltage pulses (for example, suppressing normal injector control and allowing break loose injector control), and after the energizing commencing ignition to rotate the engine (for example, by suppressing break loose injector control and allowing normal injector control).

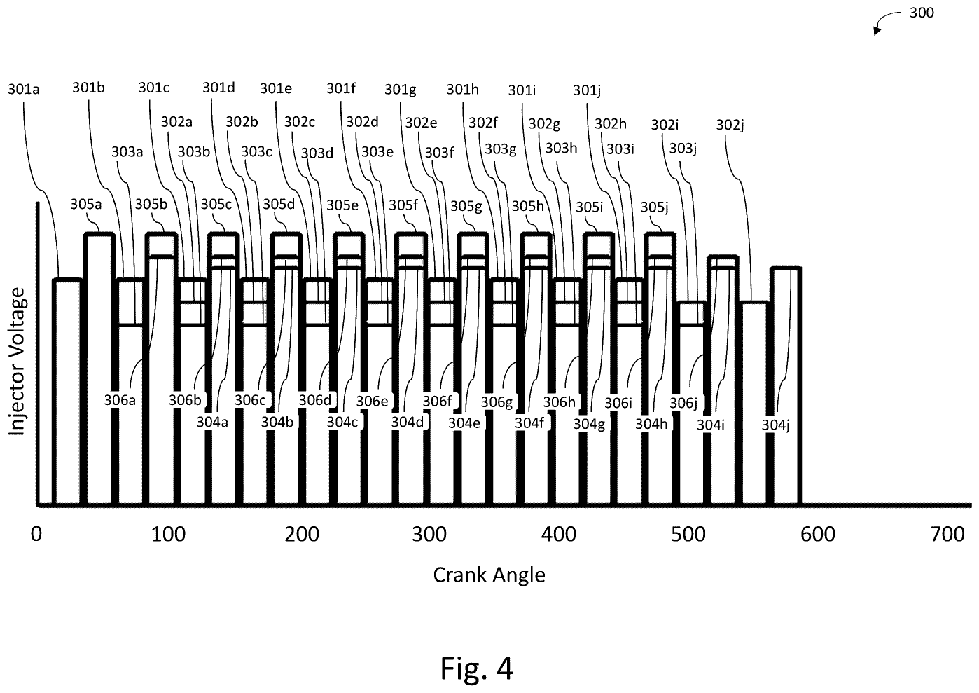

With reference to FIG. 4, there is illustrated a graph 300 depicting injector voltage as a function of engine crank angle. Graph 300 further depicts a plurality of voltage pulses including a first set of voltage pulses 301a-301j which are utilized to drive a first fuel injector, a second set of voltage pulses 302a-302j which are utilized to drive a second fuel injector, a third set of voltage pulses 303a-303j which are utilized to drive a third fuel injector, a fourth set of voltage pulses 304a-304j which are utilized to drive a fourth fuel injector, a fifth set of voltage pulses 305a-305j which are utilized to drive a fifth fuel injector, and a sixth set of voltage pulses 306a-306j which are utilized to drive a sixth fuel injector.

While various ones of the first through sixth sets of voltage pulses are depicted at different vertical axis positions for purposes of illustration, it shall be appreciated that the injector voltage magnitudes the first through sixth sets of voltage pulses may comprise the same or substantially the same voltage or may comprise different voltages. Similarly, it shall be appreciated that the injector current magnitudes corresponding to the first through sixth sets of voltage pulses may comprise the same or substantially the same current magnitudes or may comprise different current magnitudes. It shall be appreciated that by some technical conventions, internally to the ECM, pulses which communicate with an injector drivers (also referred to as voltage signals or logic signals) may be considered the relevant signal and, outside of the ECM, injector current may be considered as the relevant signal. Notwithstanding such conventions, either voltage or current may in principle be considered and utilized internally and externally of the ECM,

The plurality of pulses of each of the first through sixth sets of voltage pulses may comprise the same or substantially the same voltage or may comprise different voltages. Additionally, each of the first through sixth sets of voltage pulses comprises ten voltage pulses in the illustrated example, but in other example may comprise different numbers of pulses, which may be the same for each of plurality of sets of voltage pulses or which may vary among different sets of voltage pulses.

Each of the plurality of sets of voltage pulses depicted in graph 300 is an example of a set of multiple voltage pulses that are performed within a single engine revolution of 720 degrees or two crank revolutions of 360 degrees. Each of the plurality of sets of voltage pulses depicted in graph 300 is also an example of a set of multiple voltage pulses that are performed within 400 milliseconds or less while the engine is rotating a cranking speed, such as about 300 rpm. It shall be appreciated that such sets of pulses may be applied while the engine is rotating and while the engine is not rotating and, in the latter case, the illustrated crank angle values may be treated as theoretical rather than actually instantiated.

The plurality of sets of voltage pulses depicted in graph 300 is an example of a plurality of sets of multiple voltage pulses that are performed within a single engine revolution of 720 degrees or two crank revolutions of 360 degrees. The plurality of sets of voltage pulses depicted in graph 300 is also an example of a plurality of sets of voltage pulses that are performed within about 400 milliseconds or less, it being appreciated that such plurality of sets of pulses may be applied while the engine is rotating and while the engine is not rotating and, in the latter case, the illustrated crank angle values may be treated as theoretical rather than actually instantiated.

The plurality of sets of voltage pulses depicted in graph 300 is also an example of interleaving of a interleaving of sets of voltage pulses. In the illustrated example the first set of first set of voltage pulses 301a-301j occur at a first frequency and first phasing. The first set voltage pulses 301a-301j and are staged relative to and partially overlap with the second set of voltage pulses 302a-302j and the a third set of voltage pulses 303a-303j which also occur at the first frequency and first phasing but with different start and end times. The fourth set of voltage pulses 304a-304j occur at the first frequency but at a second phasing offset from the first phasing. The fourth set of voltage pulses 304a-304j are staged relative to and partially overlap with the fifth set of voltage pulses 305a-305j and the sixth set of voltage pulses 306a-306j which also occur at the first frequency and second phasing but with different start and end times.

In the illustrated example, the first phasing and the second phasing are selected such that their respective sets of voltage pulses do not overlap. In other embodiments, the first phasing and the second phasing are selected such that their respective sets of voltage pulses partially overlap. Additionally, other embodiments may utilize a different number of phasings, such as three or more phasings, various ones of which may be partially overlapping or non-overlapping.

The interleaving of plurality of sets of voltage pulses depicted in graph 300 may be selected and performed to concurrently optimize a first objective of completing a plurality of sets of voltage pulses corresponding to a plurality of injectors within a minimized time and a second objective of limiting maximum current draw resulting from the sets of voltage pulses. It shall be appreciated that a variety of other interleavings and interleaved arrangements and timings of voltage pulses are contemplated. The interleaving of plurality of sets of voltage pulses depicted in graph 300 also provide an example of energizing each of a plurality of gaseous fuel injectors with multiple voltage pulses that may occur within a single engine cycle.

In some embodiments, multi-level current pulse techniques (e.g., two-level current pulses, three-level current pulses, or in principle higher order multi-level current pulses) may be utilized, for example, in connection with magnetic actuators wherein electromagnetic force is inversely proportional with the square of distance. In such embodiments, a high level of current to may be utilized to pull-in an injector armature long enough for it to move up against a solenoid. Once the armature is against the solenoid, the magnetic force is stronger, and a lower hold current may be utilized to hold the armature against the solenoid. Such techniques may reduce or eliminate a reliance on interleaving entire pulses and may interleave only pull-in phases of the pulses. Some such techniques may utilize break loose pulses with a duration only during a higher current pull-in phase and may omit a lower current hold current phase. Some such techniques may could alter a pull-in current to be at the maximum current limit of an ECM. For example, if an ECM has a 36A capacity for injector current draw, two injectors firing concurrently at 18A may be utilized, three injectors firing concurrently at 18A may be utilized, or other factorizations within the 36A aggregate limit may be utilized.

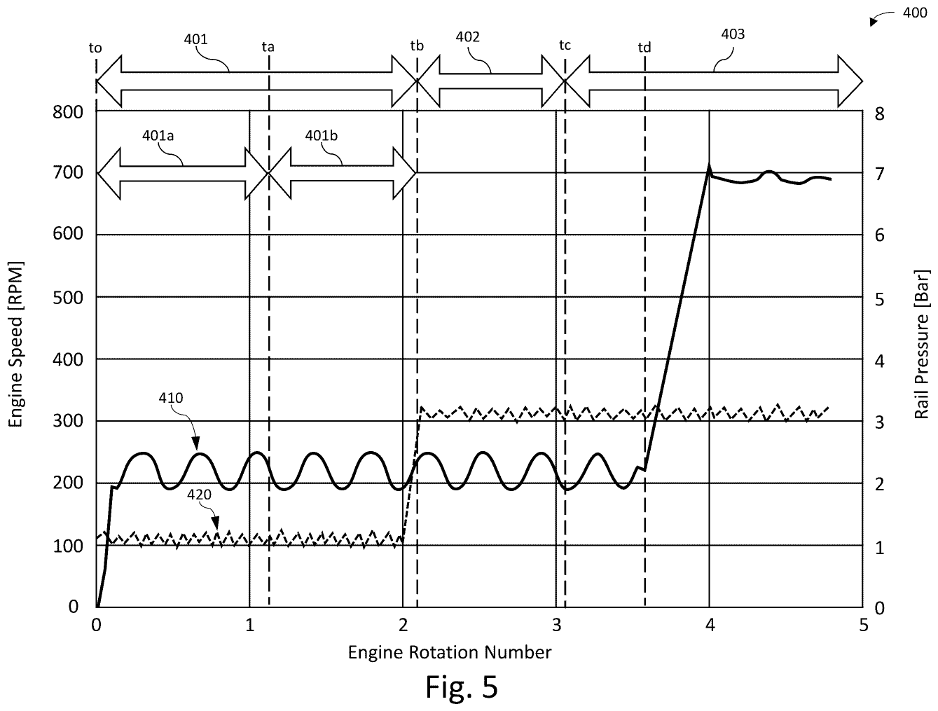

With reference to FIG. 5, there is illustrated a graph 400 depicting engine speed and fuel rail pressure as a function of number of engine rotations. Graph 400 further depicts engine speed curve 410 and gaseous fuel pressure curve 420 during an example cold start operational sequence. The example cold start operational sequence comprises a first control stage 401, a second control stage 402, and a third control stage 403.

Starting at time t0, first control stage 4-1 is entered and an engine start operation is initiated and a starter motor is energized to begin cranking operation of an engine. In response, engine speed curve 610 rises to a cranking speed range of between about 190 and 250 RPM in the illustrated example. Cranking operation of the engine continues until a time corresponding to time td after engine rotation number three at which time engine combustion is sufficiently established to independently rotate the engine and the starter motor may be de-energized and turned off. Thereafter, engine speed curve 410 rises to an idle speed of about 700 RPM in the illustrated example.

During control stage 401, a fuel shut-off valve (FSOV) is closed, spark ignition is suppressed, normal fuel injection and normal fuel injector control are suppressed, and break loose fuel injector operation and break loose fuel injector control are allowed and may be performed. First control stage 401 is divided into a control segment 401a and a control segment 401b. During control segment 401a, a crank angle position which is initially unknown is established, for example, by establishing a crank angle sensor position or by establishing a crank angle sensor position and an engine cycle position.

At time ta, second control segment 401b is entered. During control segment 401b, a break loose operation is performed, for example, by energizing each of the plurality of gaseous fuel injectors with multiple voltage pulses. In some embodiments, the energizing may comprise applying of a plurality of sets of voltage pulses depicted which may be interleaved, such as the plurality of sets of voltage pulses depicted in graph 300 or another interleaving of a plurality of sets of voltage pulses.

At time tb, second control stage 402 is entered. During second control stage 402, the fuel shut-off valve (FSOV) is opened, spark ignition is suppressed, spark ignition is suppressed, normal fuel injection and normal fuel injector control are suppressed, and break loose fuel injector operation and break loose fuel injector control are suppressed so that a fuel purge operation may be performed to clear combustion cylinders of any fuel introduced during the preceding break loose operation. Some embodiments may omit such a purge operation.

At time tc, third control stage 403 is entered. During third control stage 403 normal spark and normal injection allowed the fuel shut-off valve (FSOV) is opened, spark ignition is allowed, normal fuel injection and normal fuel injector control are allowed, and break loose fuel injector operation and break loose fuel injector control are suppressed such that normal combustion occurs.

It shall be appreciated that the operations illustrated and described in connection with graph 400 comprise an example of an engine cold start operation comprising suppressing gaseous fuel ignition, cranking the engine during the suppressing, and performing energizing of fuel injectors during the cranking to perform a break loose operation. The illustrated and described operations provide an example of energizing each of a plurality of gaseous fuel injectors with multiple voltage pulses occurs within a single engine cycle. The illustrated and described operations also provide an example continuing cranking to rotate the engine for at least a second engine cycle, and after the second engine cycle, commencing normal injector operation and ignition to rotate the engine in response to combustion and ending cranking.

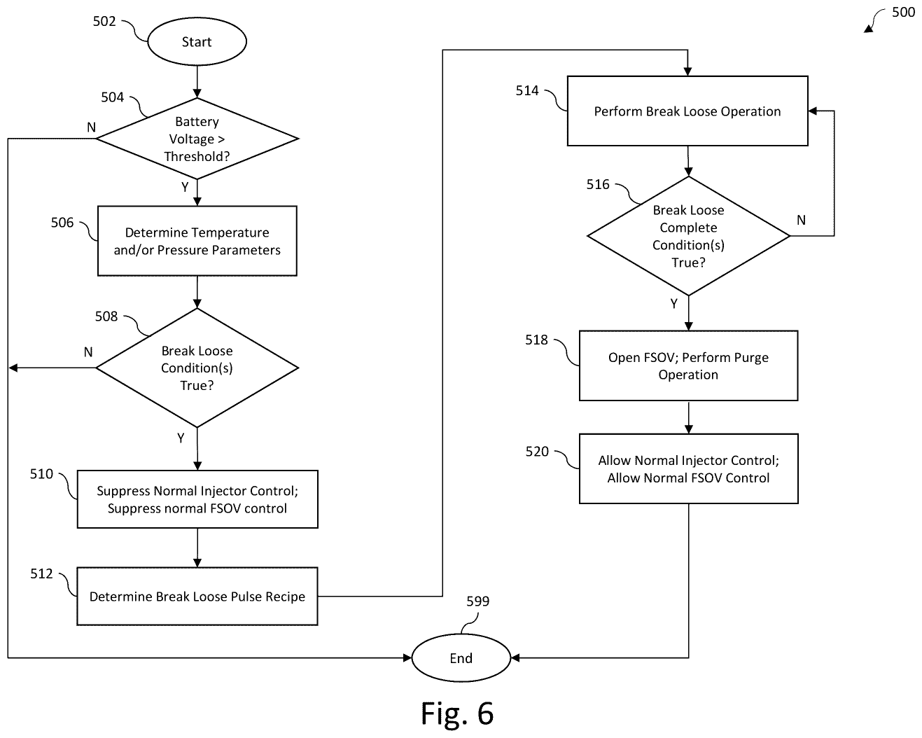

With reference to FIG. 6, there is illustrated an example control process 500 (also referred to herein as process 500). Process 500 begins at start operation 502 which may comprise any of a number of events. In some embodiments, start operation 502 may comprise an engine key-on event or an engine start command event. In some embodiments, start operation 502 may comprise a post-engine shut down or a post engine key-off timer event.

From operation 502, process 500 proceeds to conditional 504 which evaluates whether a battery voltage is greater than a threshold. If conditional 504 evaluates negative, process 500 proceeds to end operation 599. If conditional 504 evaluates affirmative, process 500 proceeds to operation 506.

Operation 506 determines a temperature parameter and/or a pressure parameters, for example, using techniques such as those described herein. From operation 506, process 500 proceeds to conditional 508 which evaluates whether one or more break loose conditions are true. Conditional 508 may, for example, perform evaluations of a temperature parameter and/or a pressure parameters determined at operation 506, for example using techniques such as those described herein such as the techniques described in connection with controls 200, graph 300, and/or graph 400.

If conditional 508 evaluates negative, process 500 proceeds to end operation 599. If conditional 508 evaluates affirmative, process 500 proceeds to operation 510. Operation 510 suppresses normal injector control thereby inhibiting normal operation of a plurality of fuel injectors and suppressed normal FSOV control thereby closing a FSOV and inhibiting normal control of the FSOV.

From operation 510, process 500 proceeds to operation 512 which determines a break loose pulse recipe, for example, using techniques such as those described herein such as the techniques described in connection with controls 200, graph 300, and/or graph 400. From operation 512, process 500 proceeds to operation 514 which performs the break loose operation using a plurality of injectors, for example, including operations such as those described herein.

From operation 514, process 500 proceeds to conditional 516 which evaluates whether one or more break loose complete conditions are complete. Conditional 516 may evaluate whether a predetermined amount of time has elapsed, whether a predetermined number of crank or engine revolutions have occurred, whether an injector pressure drop occurs, and/or whether an injector current back EMF notch is observed.

From conditional 516, process 500 proceeds to operation 518 which opens the FSOV and preforms a fuel purge operation, for example, using techniques such as those described herein such as the techniques described in connection with controls 200, graph 300, and/or graph 400. From operation 518, process 500 proceeds to operation 520 which allows normal injector control and allows normal FSOV control, for example, using techniques such as those described herein such as the techniques described in connection with controls 200, graph 300, and/or graph 400.

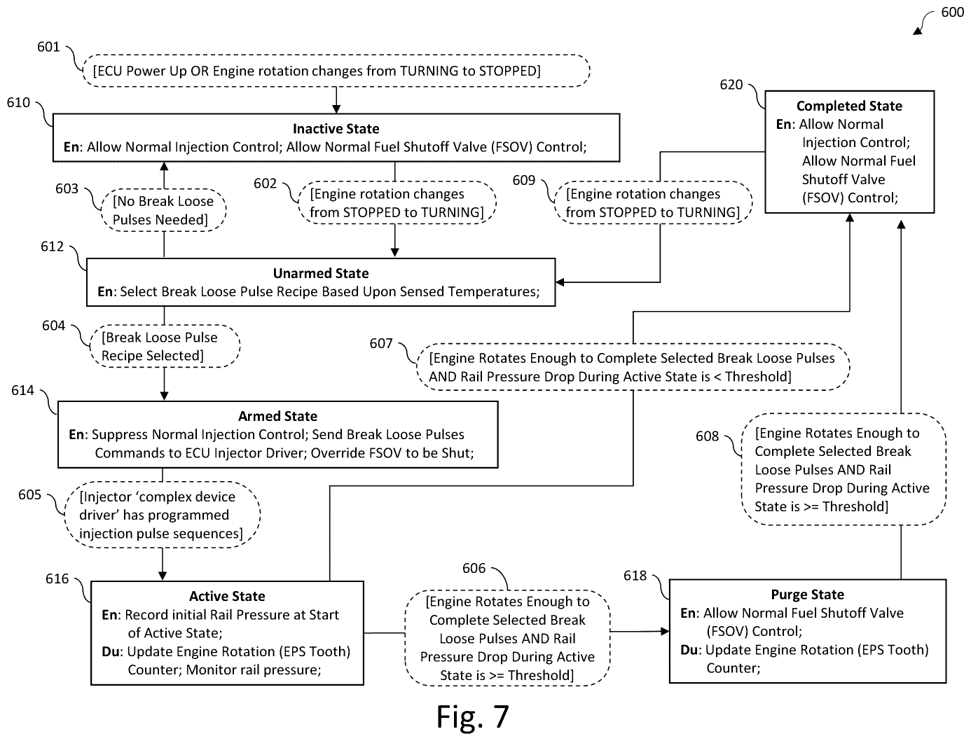

With reference to FIG. 7, there is illustrated a flow state diagram illustrating certain aspects of controls 600 which may be implemented in and operated by one or more control components of an electronic control system, for example, ECU 22 of ECS 20 or another electronic control system component. Controls 600 and their operation are examples of controls and a control process configured and operable to perform injector break loose operation in response to an engine start event initiated at any time.

Controls 600 are configured and operable to enter a plurality of states including inactive state 610, unarmed state 612, armed state 614, active state 616, purge state 618, and completed state 620. Controls 600 are configured and operable to enter particular ones of the plurality of states and to transition from certain ones of the plurality of states to other ones of the plurality of states based upon a plurality of conditions 601-608.

From any state of controls 600, if conditions 601 are satisfied, controls 600 transition to inactive state 610. Conditions 601 are satisfied if an ECU power up condition is present or an engine rotation condition changes from turning to stopped.

Upon entering inactive state 610, controls 600 perform normal injection control and normal fuel shutoff valve (FSOV) control. Normal injection control and normal FSOV control may comprise a number of control schemes in which injector control commands and normal FSOV control commands may be determined in response to torque or fueling demands as well as other parameters, for example, engine speed, mass air flow, intake manifold pressure, intake manifold temperature, fuel pressure and/or fuel temperature, and controls 600 do not operate to break loose potentially stuck valves of gaseous fuel injectors to condition gaseous fuel injectors for cold engine start conditions.

While in inactive state 610, if conditions 602 are satisfied, controls 600 transition to unarmed state 612. Conditions 602 are satisfied if engine rotation changes from stopped to turning, for example, during engine cranking wherein the engine is driven by a starter motor.

Upon entering unarmed state 612, controls 600 perform selection of a break loose pulse recipe in response to one or more break loose pulse recipe determination criteria. The break loose pulse recipe determination criteria may include determinations based on one or more temperature determinations, one or more fuel pressure determinations, one or more temperature determinations and one or more fuel pressure determinations, and/or other criteria from which a potentially stuck gaseous fuel injector valve may be determined or predicted.

While in unarmed state 612, if conditions 603 are satisfied, controls 600 transition to inactive state 610. Conditions 603 are satisfied if it is determined that break loose pulses operation is not needed.

While in unarmed state 612, if conditions 604 are satisfied, controls 600 transition to armed state 614. Conditions 604 are satisfied if a break loose pulse recipe is selected.

Upon entering armed state 614, controls 600 suppress normal injection control, control a fuel shut-off valve (FSOV) to be shut or closed, and send break loose pulses commands to ECU Injector Driver. Controls 600 may suppress normal injection control, or more generally any other suppressed control or operation, in any of various manners including the examples disclosed herein.

While in armed state 614, if conditions 605 are satisfied, controls 600 transition to active state 616. Conditions 605 are satisfied if parameters of a break loose pulse operation have been selected or established, for example, if an injector driver has been successfully programmed with or set to perform an injection pulse sequences.

Upon entering active state 616, controls 600 record an initial rail pressure (for example, at the start of the active state). During the active state controls 600 update an engine rotation counter (for example, an engine position sensor tooth count) and monitor rail pressure. In some embodiments, the active state may be terminated based on other feedbacks such as a back electromotive force (BEMF) feedback from each injector.

While in active state 616, if conditions 606 are satisfied, controls 600 transition to purge state 618. Conditions 606 are satisfied if a break loose operation is completed, for example, if the engine rotates enough to complete a selected break loose operation, and rail pressure drop during the active state 616 is greater than a threshold indicating that an amount of gaseous fuel introduced during active state is sufficiently high as to require purging.

While in active state 616, if conditions 607 are satisfied, controls 600 transition to completed state 620. Conditions 607 are satisfied if a break loose operation is completed, for example, if the engine rotates enough to complete a selected break loose operation, and rail pressure drop during the active state 616 is less than a threshold indicating that an amount of gaseous fuel introduced during active state is sufficiently low as to not require purging.

Upon entering purge state 618, controls 600 allow normal fuel shutoff valve (FSOV) control. During the purge state, update controls 600 update an engine rotation counter.

While in purge state 618, if conditions 607 are satisfied, controls 600 transition to completed state 620. Conditions 607 are satisfied if a purge operation is completed, for example, if the engine rotates sufficiently that fuel present in combustion cylinders is deemed to have been purged.

Upon entering completed state 620, controls 600 allow normal injection control and allow normal FSOV control. While in completed state 620 if conditions 609 are satisfied, controls 600 transition to unarmed state 612. Conditions 609 are satisfied engine rotation changes from stopped to turning.

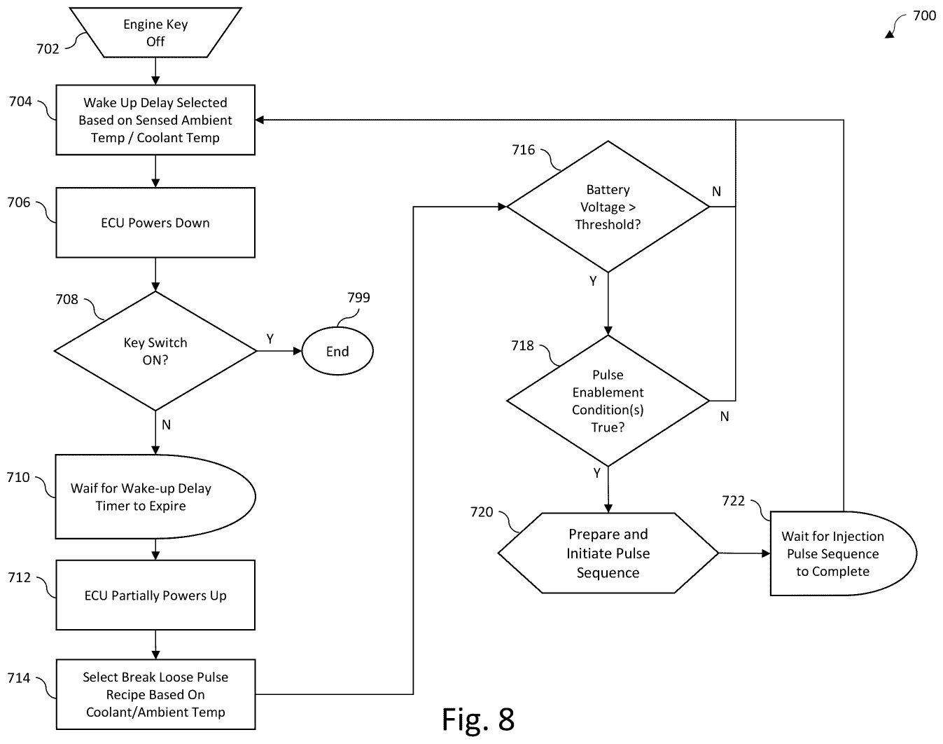

With reference to FIG. 8, there is illustrated a flow diagram illustrating certain aspects of an example control process 700 (also referred to herein as process 700). Process 700 is an example of a control process configured and operable to perform injector break loose operation after and engine shut-down event and prior to a potential engine start event that may occur at an indefinite future time.

Process 700 begins at operation 702 at which an engine key-off event or another engine shut-down event occurs. From operation 702, process 700 proceeds to operation 704 which determines or sets a wake-up delay in response to a temperature determination, for example, a coolant temperature or ambient temperature, rail temperature, or another system temperature. Operation 704 may determine or set the wake-up delay according to a prediction of a potential engine cold start operation and/or a grade or severity a potential engine cold start operation.

From operation 704, process 700 proceeds to operation 706 which powers down the ECU. From operation 706, process 700 proceeds to conditional 708 which evaluates whether a key switch is on. If conditional 708 evaluates affirmative, process 700 proceeds to end operation 799.

If conditional 708 evaluates negative, process 700 proceeds to operation 710 which waits for the wake-up delay timer to expire. From operation 710, process 700 proceeds to operation 712 which partially powers up the ECU in response to expiration of the wake-up delay timer.

From operation 712, process 700 proceeds to operation 714 which determines a break loose pulse recipe. Operation 712 may determine a break loose recipe based on a number of criteria, for example, based on one or more temperature determinations (such as coolant temperature, ambient temperature, rail temperature, or another system temperature), one or more fuel pressure determinations, one or more temperature determinations and one or more fuel pressure determinations, and/or other criteria from which a potentially stuck gaseous fuel injector valve may be determined or predicted.

From operation 714, process 700 proceeds to conditional 716 which evaluates whether a battery voltage is greater than a threshold. If conditional 716 evaluates negative, process 700 proceeds to operation 704.

If conditional 716 evaluates affirmative, process 700 proceeds to conditional 718 which evaluates whether one or more pulse enablement conditions is true. Conditional 718 may evaluate whether one or more pulse enablement conditions is true for example, based on one or more temperature determinations (such as coolant temperature, ambient temperature, rail temperature, or another system temperature), one or more fuel pressure determinations, one or more temperature determinations and one or more fuel pressure determinations, and/or other criteria from which a potentially stuck gaseous fuel injector valve may be determined or predicted.

If conditional 718 evaluates negative, process 700 proceeds to operation 704. If conditional 718 evaluates affirmative, process 700 proceeds to operation 720 which prepares and initiates a break loose pulse sequence, for example, by programming or setting a break loose injector pulse sequence into one or more injector drivers and executing or preforming the break loose injector pulse sequence.

From operation 720, process 700 proceeds to operation 722 which waits for the break loose injector pulse sequence to complete. From operation 722, process 700 proceeds to operation 704.

As shown by this detailed description, the present disclosure contemplates multiple and various embodiments including, without limitation, the following example embodiments.

A first example embodiment, is an engine system comprising: a gaseous fuel injection system including a plurality of gaseous fuel injectors configured to inject gaseous fuel for combustion in a plurality of cylinders; and an electronic control system operatively coupled with the gaseous fuel injection system, the electronic control system being configured to perform the acts of: performing a break loose operation comprising energizing each of the plurality of gaseous fuel injectors with multiple voltage pulses, and after the energizing commencing ignition to rotate the engine.

A second example embodiment includes the features of the first example embodiment, wherein the multiple voltage pulses occur within a time window of 400 ms or less at an engine speed of 300 rpm.

A third example embodiment includes the features of the first example embodiment, wherein the multiple voltage pulses comprise a first set of multiple voltage pulses driving a first gaseous fuel injector and a second set of multiple voltage pulses driving a second gaseous fuel injector, the first set of multiple voltage pulses being interleaved with the second set of multiple voltage pulses.

A fourth example embodiment includes the features of the third example embodiment, wherein the first set of multiple voltage pulses being interleaved with the second set of multiple voltage pulses comprises the first set of voltage pulses not overlapping with the second set of multiple voltage pulses.

A fifth example embodiment includes the features of the first example embodiment, comprising suppressing gaseous fuel ignition, cranking the engine during the suppressing, and performing the energizing during the cranking.

A sixth example embodiment includes the features of the first example embodiment, wherein the energizing each of the plurality of gaseous fuel injectors with multiple voltage pulses occurs within a single engine cycle.

A seventh example embodiment includes the features of the sixth example embodiment, wherein the act of commencing ignition to rotate the engine comprises: after the energizing continuing the rotating for at least a second engine cycle, and after the second engine cycle, performing the commencing ignition to rotate the engine.

An eighth example embodiment includes the features of the first example embodiment, wherein the electronic control system is configured to perform the act of determining whether to perform a break loose operation of the plurality of injectors.

A ninth example embodiment includes the features of the eighth example embodiment, wherein the act of determining comprises at least one of evaluating a temperature of the engine system and a pressure of the gaseous fuel system.

A tenth example embodiment includes the features of the first example embodiment, comprising evaluating at least one of a temperature of the engine system and a pressure of the gaseous fuel system, and determining a multiple voltage pulse recipe in response to the evaluating.

An eleventh example embodiment includes the features of the first example embodiment, wherein the gaseous fuel injection system is the sole fuel injection system of the engine system.

A twelfth example embodiment includes the features of the first example embodiment, wherein the energizing each of the plurality of gaseous fuel injectors with multiple voltage pulses occurs at least in part during a stationary engine condition.

A thirteenth example embodiment is a process comprising: operating a system comprising a gaseous fuel injection system including a plurality of gaseous fuel injectors configured to inject gaseous fuel for combustion in a plurality of cylinders and an electronic control system operatively coupled with the gaseous fuel injection system, including operating the electronic control system to perform the acts of: determining whether to perform a break loose operation of the plurality of injectors, performing a break loose operation including energizing each of the plurality of gaseous fuel injectors with multiple voltage pulses, and after the energizing commencing ignition to rotate the engine.

A fourteenth example embodiment includes the features of the thirteenth example embodiment, wherein the multiple voltage pulses occur within a time window of 400 ms or less at an engine speed of 300 rpm.

A fifteenth example embodiment includes the features of the thirteenth example embodiment, wherein the multiple voltage pulses comprise a first set of multiple voltage pulses driving a first gaseous fuel injector and a second set of multiple voltage pulses driving a second gaseous fuel injector, the first set of multiple voltage pulses being interleaved with the second set of multiple voltage pulses.

A sixteenth example embodiment includes the features of the fifteenth example embodiment, wherein the first set of multiple voltage pulses being interleaved with the second set of multiple voltage pulses comprises the first set of voltage pulses not overlapping with the second set of multiple voltage pulses.

A seventeenth example embodiment includes the features of the thirteenth example embodiment, comprising suppressing gaseous fuel ignition, cranking the engine during the suppressing, and performing the energizing during the cranking.

A eighteenth example embodiment includes the features of the thirteenth example embodiment, wherein the energizing each of the plurality of gaseous fuel injectors with multiple voltage pulses occurs within a single engine cycle.

A nineteenth example embodiment includes the features of the eighteenth example embodiment, wherein the act of commencing ignition to rotate the engine comprises: after the energizing continuing the rotating for at least a second engine cycle, and after the second engine cycle, performing the commencing ignition to rotate the engine.

A twentieth example embodiment includes the features of the thirteenth example embodiment, wherein the act of determining comprises at least one of evaluating a temperature of the engine system and a pressure of the gaseous fuel system.

A twenty-first example embodiment includes the features of the thirteenth example embodiment, comprising evaluating at least one of a temperature of the engine system and a pressure of the gaseous fuel system, and determining a multiple voltage pulse recipe in response to the evaluating.

A twenty-second example embodiment includes the features of the thirteenth example embodiment, wherein the gaseous fuel injection system is the sole fuel injection system of the engine system.

A twenty-third example embodiment includes the features of the thirteenth example embodiment, wherein the energizing each of the plurality of gaseous fuel injectors with multiple voltage pulses occurs at least in part during a stationary engine condition.

A twenty-fourth example embodiment includes the features of the thirteenth example embodiment, comprising determining whether to perform a break loose operation of the plurality of injectors.

A twenty-fifth example embodiment includes the features of the twenty-fourth example embodiment, wherein the act of determining comprises at least one of evaluating a temperature of the engine system and a pressure of the gaseous fuel system.

It shall be appreciated that terms such as “a non-transitory memory,” “a non-transitory memory medium,” and “a non-transitory memory device” refer to a number of types of devices and storage mediums which may be configured to store information, such as data or instructions, readable or executable by a processor or other components of a computer system and that such terms include and encompass a single or unitary device or medium storing such information, multiple devices or media across or among which respective portions of such information are stored, and multiple devices or media across or among which multiple copies of such information are stored.

It shall be appreciated that terms such as “determine,” “determined,” “determining” and the like when utilized in connection with a control method or process, an electronic control system or controller, electronic controls, or components or operations of the foregoing refer inclusively to a number of acts, configurations, devices, operations, and techniques including, without limitation, calculation or computation of a parameter or value, obtaining a parameter or value from a lookup table or using a lookup operation, receiving parameters or values from a datalink or network communication, receiving an electronic signal (e.g., a voltage, frequency, current, or pulse-width modulation (PWM) signal) indicative of the parameter or value, receiving output of a sensor indicative of the parameter or value, receiving other outputs or inputs indicative of the parameter or value, reading the parameter or value from a memory location on a computer-readable medium, receiving the parameter or value as a run-time parameter, and/or by receiving a parameter or value by which the interpreted parameter can be calculated, and/or by referencing a default value that is interpreted to be the parameter value.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. An engine system comprising:
a gaseous fuel injection system including a plurality of gaseous fuel injectors configured to inject gaseous fuel for combustion in a plurality of cylinders; and
an electronic control system operatively coupled with the gaseous fuel injection system, the electronic control system being configured to perform the acts of:
performing a break loose operation comprising energizing each of the plurality of gaseous fuel injectors with multiple voltage pulses, and
after the energizing commencing ignition to rotate the engine.

2. The engine system of claim 1, wherein the multiple voltage pulses occur within a time window of 400 ms or less at an engine speed of 300 rpm.

3. The engine system of claim 1, wherein the multiple voltage pulses comprise a first set of multiple voltage pulses driving a first gaseous fuel injector and a second set of multiple voltage pulses driving a second gaseous fuel injector, the first set of multiple voltage pulses being interleaved with the second set of multiple voltage pulses.

4. The engine system of claim 3, wherein the first set of multiple voltage pulses being interleaved with the second set of multiple voltage pulses comprises the first set of voltage pulses not overlapping with the second set of multiple voltage pulses.

5. The engine system of claim 1, comprising suppressing gaseous fuel ignition, cranking the engine during the suppressing, and performing the energizing during the cranking.

6. The engine system of claim 1, wherein the energizing each of the plurality of gaseous fuel injectors with multiple voltage pulses occurs within a single engine cycle.

7. The engine system of claim 6, wherein the act of commencing ignition to rotate the engine comprises: after the energizing continuing the rotating for at least a second engine cycle, and after the second engine cycle, performing the commencing ignition to rotate the engine.

8. The engine system of claim 1, wherein the electronic control system is configured to perform the act of determining whether to perform a break loose operation of the plurality of injectors.

9. The engine system of claim 8, wherein the act of determining comprises at least one of evaluating a temperature of the engine system and a pressure of the gaseous fuel system.

10. The engine system of claim 1, comprising evaluating at least one of a temperature of the engine system and a pressure of the gaseous fuel system, and determining a multiple voltage pulse recipe in response to the evaluating.

11. The engine system of claim 1, wherein the gaseous fuel injection system is the sole fuel injection system of the engine system.

12. The engine system of claim 1, wherein the energizing each of the plurality of gaseous fuel injectors with multiple voltage pulses occurs at least in part during a stationary engine condition.

13. A process comprising:
operating a system comprising a gaseous fuel injection system including a plurality of gaseous fuel injectors configured to inject gaseous fuel for combustion in a plurality of cylinders and an electronic control system operatively coupled with the gaseous fuel injection system, including operating the electronic control system to perform the acts of:
determining whether to perform a break loose operation of the plurality of injectors,
performing a break loose operation including energizing each of the plurality of gaseous fuel injectors with multiple voltage pulses, and
after the energizing commencing ignition to rotate the engine.

14. The process of claim 13, wherein the multiple voltage pulses occur within a time window of 400 ms or less at an engine speed of 300 rpm.

15. The process of claim 13, wherein the multiple voltage pulses comprise a first set of multiple voltage pulses driving a first gaseous fuel injector and a second set of multiple voltage pulses driving a second gaseous fuel injector, the first set of multiple voltage pulses being interleaved with the second set of multiple voltage pulses.

16. The process of claim 15, wherein the first set of multiple voltage pulses being interleaved with the second set of multiple voltage pulses comprises the first set of voltage pulses not overlapping with the second set of multiple voltage pulses.

17. The process of claim 13, comprising suppressing gaseous fuel ignition, cranking the engine during the suppressing, and performing the energizing during the cranking.

18. The process of claim 13, wherein the energizing each of the plurality of gaseous fuel injectors with multiple voltage pulses occurs within a single engine cycle.

19. The process of claim 18, wherein the act of commencing ignition to rotate the engine comprises: after the energizing continuing the rotating for at least a second engine cycle, and after the second engine cycle, performing the commencing ignition to rotate the engine.

20. The process of claim 13, wherein the act of determining comprises at least one of evaluating a temperature of the engine system and a pressure of the gaseous fuel system.

21. The process of claim 13, comprising evaluating at least one of a temperature of the engine system and a pressure of the gaseous fuel system, and determining a multiple voltage pulse recipe in response to the evaluating.

22. The process of claim 13, wherein the gaseous fuel injection system is the sole fuel injection system of the engine system.

23. The process of claim 13, wherein the energizing each of the plurality of gaseous fuel injectors with multiple voltage pulses occurs at least in part during a stationary engine condition.

24. The process of claim 13, comprising determining whether to perform a break loose operation of the plurality of injectors.

25. The process of claim 24, wherein the act of determining comprises at least one of evaluating a temperature of the engine system and a pressure of the gaseous fuel system.
